(19) United States
(12) Patent Application Publication
(10) Pub. No.: US 2017/0180599 A1
(43) Pub. Date: Jun. 22, 2017

(54) ELECTRONIC DEVICE AND NON-TRANSITORY COMPUTER-READABLE STORAGE MEDIUM

(71) Applicant: KYOCERA Document Solutions Inc., Osaka (JP)

(72) Inventor: Kenichiro NITTA, Osaka (JP)

(73) Assignee: KYOCERA Document Solutions Inc., Osaka (JP)

(21) Appl. No.: 15/382,691

(22) Filed: Dec. 18, 2016

(30) Foreign Application Priority Data
Dec. 18, 2015 (JP) 2015-247163

(51) Int. Cl. H04N 1/32; G06F 3/06; H04N 1/00

(52) U.S. Cl. CPC H04N 1/32683; H04N 1/00832; H04N 1/32657; G06F 3/0644; G06F 3/0608; G06F 3/0685; H04N 2201/0094; H04N 2201/3297

(57) ABSTRACT

To provide an electronic device that is capable of displaying a warning indication of urging a replacement of a memory at an optimal timing. A system control calculate a warning indication threshold value based on a ratio of a value to a TBW (guaranteed write capacity), the value being a multiplication of a sum of the data write quantity per day that are defined for a for-system partition and a for-each function partition of the SSD and specific days (for example, 3 months) before the sum of write quantities reach the TBW. The system control part, which controls data write on the aforementioned partitions, causes a panel part to display the warning indication of urging a replacement of the SSD when a remaining write capacity of the TBW reaches the warning indication threshold value.

This application is based on and claims the benefit of priority from Japanese Patent Application No. 2015-247163 filed on Dec. 18, 2015, the contents of which are hereby incorporated by reference.

### BACKGROUND

The present disclosure relates to an electronic device and a computer-readable non-transitory storage medium both of which are suitable for managing nonvolatile memories that includes, for example, SSDs (Solid State Drives).

For example, on an image forming device that is in the form of an MFP (Multifunction Peripheral) acting as a printer, a multifunctional printer, a multifunctional machine, or the like, there is mounted a large capacity HDD (Hard Disk Drive) for performing multi operation of each jobs including copy, print, FAX (facsimile), or the like, and for realizing a user box function. Such an image forming device is also capable of being mounted with a nonvolatile memory such as a SSD using an NAND type flash memory (Registered Trademark) with a high speed access for data reading/writing. Further, such an image forming device is capable of mounting with only a nonvolatile memory such as a SSD without mounting an HDD.

Incidentally, while the SSD has a merit of higher speed access for data reading/writing than the HDD, the SSD has a demerit of data write lifetime is short due to the structure of the flash memory (registered trademark). For this reason, if the SSD that is in use comes to its lifetime, there may be a fear of an abnormal operation or a malfunction of the image forming device.

For overcoming the aforementioned defects, a data storage control device, as a typical technique, has been known. This data storage control device includes a counter that counts number of times of writing a data on a first nonvolatile memory whose guaranteed number of times of rewriting is small for each partition and a control part that causes data to be written into a second nonvolatile memory whose guaranteed number of times of rewriting is large, if the number of times of writing data on the first nonvolatile memory in which the data is to be written is in excess of a specified number of times.

### SUMMARY

An electronic device according to the present disclosure has feature to include a panel part that displays information, a first memory, and a system control part that calculates a warning indication threshold value, based on a data write quantity written in a first memory, in a first time duration before the data write quantity to the first memory reaches a guaranteed write capacity, the system control part controlling a data write to the first memory and causing the panel part to display warning a requirement for replacement of the first memory if a remaining write capacity of the guaranteed write capacity reaches the warning indication threshold value.

A non-transitory computer-readable storage medium according to the present disclosure stores a memory lifetime warning program that is executable by a computer of an electronic device. The memory lifetime warning program, when being executed by the computer, causes the computer to calculate a warning indication threshold value based on a data quantity written in a first memory for a first duration before the data quantity written in the first memory reaches a guaranteed write capacity of the first memory, to control a data write in the first memory, and to cause the panel part to display warning a requirement for replacement of the first memory when a remaining write capacity of the guaranteed write capacity reaches the warning indication threshold value.

### BRIEF DESCRIPTION OF THE DRAWINGS

FIG. 1 illustrates a configuration of an MFP as an electronic device of the present disclosure;

FIG. 2A illustrates an SSD partition configuration for describing the configuration of a storage device shown in FIG. 1;

FIG. 2B illustrates an HDD partition configuration for describing the configuration of a storage device shown in FIG. 1;

FIG. 3A illustrates an exemplary definition of each partition of an SSD shown in FIG. 1 when only the SSD is mounted on the MFP;

FIG. 3B illustrates an exemplary definition of each partition of the SSD shown in FIG. 1 when an HDD is added in option;

FIG. 4A indicates a warning indication threshold value associated with a TBW (Terabytes Written) when the SSD shown in FIG. 1 occupies 8 GB;

FIG. 4B indicates a warning indication threshold value associated with a TBW (Terabytes Written) when the SSD shown in FIG. 1 occupies 32 GB;

FIG. 5 illustrates an exemplary definition of each partition of the SSD shown in FIG. 1 when the SSD has a secure function; and

FIG. 6 illustrates steps of a process for urging a replacement of the SSD shown in FIG. 1.

### DETAILED DESCRIPTION

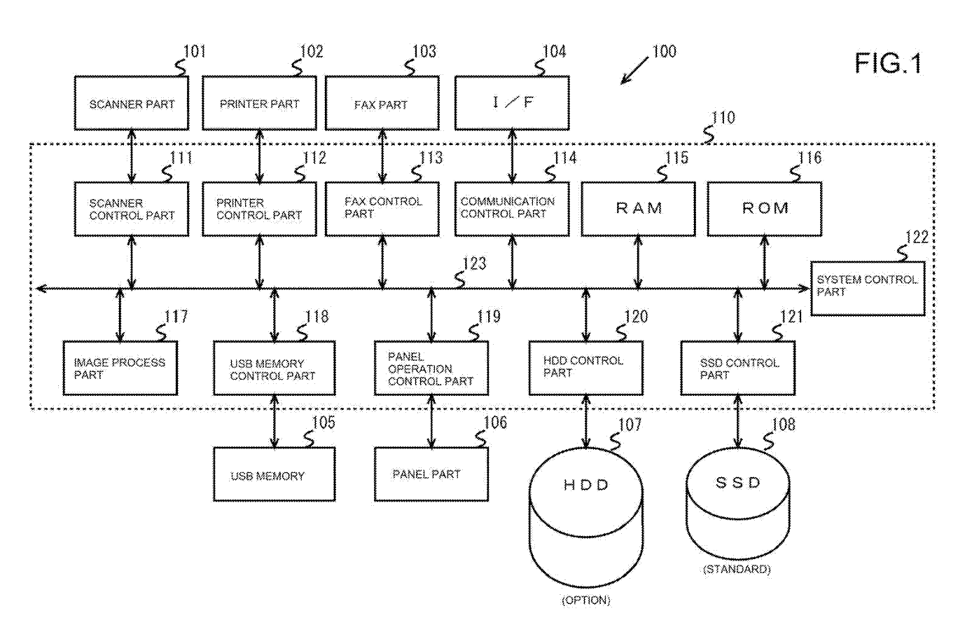

Hereinbelow, with reference to FIG. 1 to FIG. 6, a description is made as to an exemplary embodiment of an electronic device according to the present disclosure. It is to be noted that as an example of the electronic device in the following description is an MFP (Multifunction Peripheral) that is equipment on which are mounted multiple functions such as a print function, copy function, FAX function, data transceiving function via a network and the like.

First of all, as illustrated in FIG. 1, an MFP 100 includes a scanner part 101, a printer part 102, a FAX part 103, an I/F (interface) part 104, a USB memory 105, a panel part 106, an HDD (Hard Disk Drive) 107, an SSD 108, and a control part 110. It is to be noted that the present exemplary embodiment is described on the assumption that the SSD that is a nonvolatile memory is standardly mounted on the MFP 100. In addition, the HDD 107, that is optionally mounted equipment, is mounted on the MFP 100 if necessary. Further, the USB memory 105, that is a nonvolatile memory, is connected to the MFP 100 if necessary.

The scanner part 101 is a device that converts an image of a manuscript scanned by an image sensor to digital image data and inputs the resulting digital image data to the control part 110. The print part 102 is a device that makes a print an image on a paper pursuant to print data outputted from the control part 110. The FAX part 103 is a device that transmits data outputted from the control part 110 to an opposite-side facsimile machine via a public telephone line and/or receives data from the opposite-side facsimile machine to input this data to the control part 110.

The I/F 104 is a device such as a network interface card or the like, this device establishing a communication, via networks that include, for example, an in-house LAN (Local Area Network) and the Internet, to other user terminals, content servers, and web servers. The USB memory 105 is a device that stores print data, setting change data and the like. Mounting the USB memory 105 to a specific portion of the MFP 100 allows a USB memory control part 118 that will be described later to read the print data, the setting change data and the like.

The panel part 106 is a device, that is a touch panel or the like, that displays for various functions of the MFP 100 that include, for example, a print function, a copy function, a FAX function and a data transmitting/receiving function via the Internet, and indicates for various setting data. The panel part 106 also indicates warning a requirement for replacement of the SSD 108 as will be described later. It is to be noted that warning a requirement for replacement of the SSD 108, that will be detailed later, when a system control part 122 that will be described later confirms that the lifetime of the SSD 108 gets near that will be detailed later, the system control part 122 controls a panel operation part 119 that will be described later in order to indicate the confirmed fact on the panel part 106.

The HDD 107 as a second memory, that will be detailed later, is a storage device that stores, for example, application programs for providing various functions of the MFP 100. It is to be noted that as described above the HDD 107 is optional equipment that is mounted on the MFP 100 if necessary.

The SSD 108 as a first memory, that will be detailed later, is a storage device that stores, for example, application programs for providing various functions of the MFP 100, similar to the HDD 107. The SSD 108 includes a cell structure (hereinafter, that will be referred to as “cell”) as a minimum unit for data storage and a controller for controlling writing data in the cell. It is to be noted that as described above, the present exemplary embodiment assumes that the SSD 108 is a standardly mounted to the MFP 108.

The control part 110 is a processor that executes programs including, for example, an image forming program and a control program for performing the whole control of the MFP 100. The control part 110 includes a scanner control part 111, a printer control part 112, a FAX (facsimile) control part 113, a communication control part 114, a RAM (Random Access Memory) 115, a ROM (Read-Only Memory) 116, an image processing part 117, a USB memory control part 118, a panel operation control part 119, an HDD control part 120, an SSD control part 121, and a system control part 122. In addition these parts are connected to a data bus 123.

The scanner control part 111 controls a reading operation of the scanner part 101. The printer control part 112 controls a print operation of the printer part 102. The FAX control part 113 controls a facsimile transmitting/receiving operation of the FAX part 103. The communication control part 114 causes the I/F 104 to control a data transmitting/receiving operation via the network.

The RAM 115 is provided as a work memory for executing a program. In addition, the RAM 115 stores, for example, the print data that is image-processed by the image processing part 117. In the ROM 116, there is stored a control program for checking the operation of each of the parts. The image processing part 117 performs an image processing (rasterization) to the image data that the scanner part 101 reads, for example. The USB memory control part 118 allows data to access the USB memory 105. The panel operation control part 119 controls an indication operation of the panel part 106. The panel operation control part 119 also causes the panel part 106 receive initiation instructions of, for example, print, copy, FAX, and via-the-Internet data transmitting/receiving operations.

The HDD control part 120, for example, performs a control to access data to the HDD 107. The SSD control part 121, for example, performs a control to access data to the SSD 108. The system control part 122 controls associated operations between each the parts. As will be detailed later, the system control part 122 causes, via the panel operation control part 119, the panel part 106 to indicate a requirement for replacement of the SSD 108 based on a warning indication threshold value calculated by design estimation.

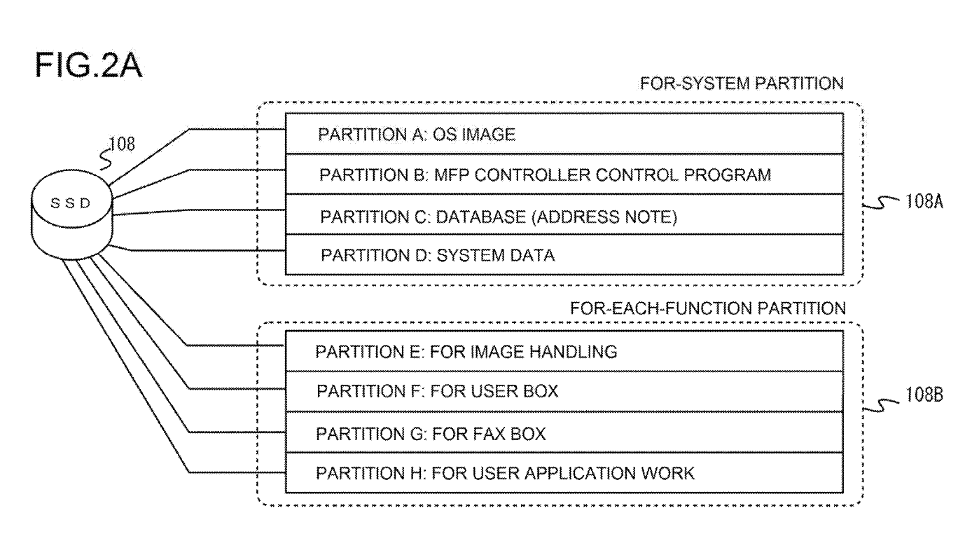

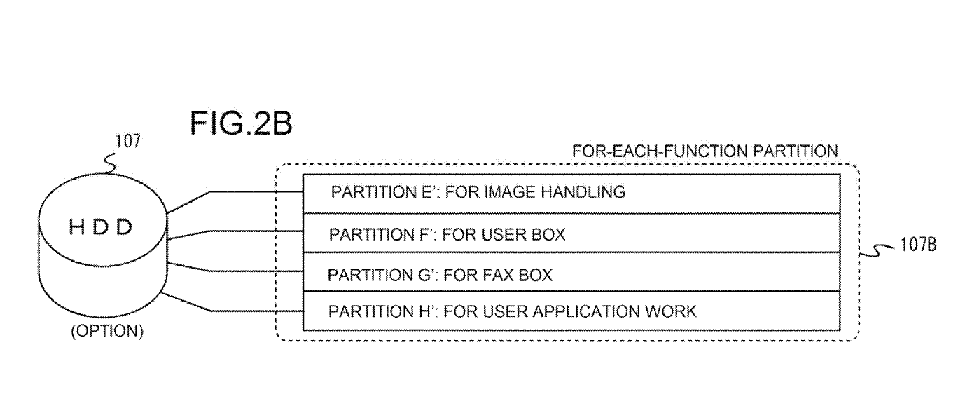

Next, with reference to FIG. 2A and FIG. 2B, configurations of the SSD 108 and HDD 107 are described. First of all, FIG. 2A illustrates the configuration of the SSD 108. The SSD 108 includes, for example, a partition 108A for system and a partition 108B for each function.

The partition 108A for system includes partitions A to D. The partition A is provided for an OS (Operating System) Image. The partition B is provided for an MFP controller control program. The partition C is provided to be used as a database such as an address note. The partition D is provided for system data.

The partition 108B for each function, which is provided as a partition for a first function, includes partitions E to H. The partition E is provided for an image handling to be used in image handling. The partition F is provided for a user box that the user uses as a box function. The partition G is provided for a FAX box to be used as a FAX function. The partition H is provided for a user application work to be used as a work area when a user application is installed.

In addition, the partitions A to H are allocated in a virtual memory area and therefore specific cells of the SSD 108 do not correspond to specific partitions, statically. Actually, the controller of the SSD 108 performs a control to write data in a cell (that is, a cell that does not correspond to data stored in the virtual memory area) in which no data is written. When writing such data, it is possible to cause the controller of the SSD 108 to average the writing number of times of data in each of the cells (not to prevent an unbalanced writing number of times between the cells).

FIG. 2B illustrates the configuration of the HDD 107 that is added optionally. The HDD 107 includes a partition 107B for each function that is made up of partitions E′ to H′. It is to be noted that the partition 107B for each function, that is provided as a partition for a second each function, is similar to the partition 108B as described above for each function in configuration. That is to say, the partition E′ is provided for an image handling to be used in image handling. The partition F′ is provided for a user box that the user uses as a box function. The partition G′ is provided for a FAX box to be used as a FAX function. The partition H′ is provided for a user application work to be used as a work area when a user application is installed.

It is to be noted that the partition 107B for each function that is at the side of the HDD 107 is used when the HDD 107 is optionally added. The reason is that the storage capacity at the side of HDD107 is larger than that at the side of the SSD 108. In this case, the partition 108B for each function at the side of the SSD 108 is not used.

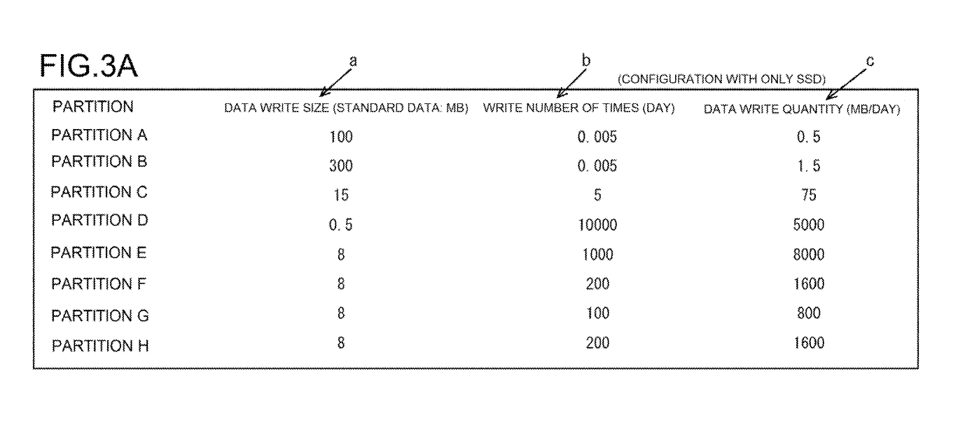

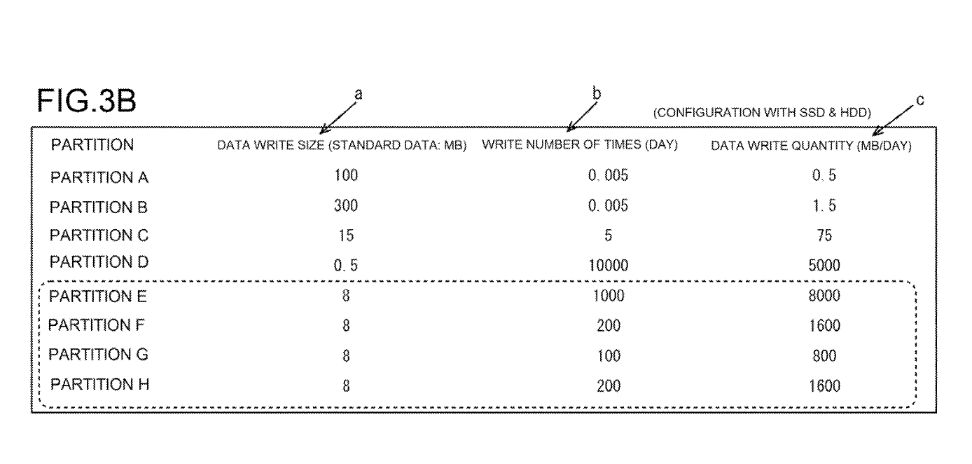

Next, with reference to FIG. 3A and FIG. 3B, a definition and others are exemplary described that are, for example, data write quantity to be written in each of the partitions A to H of the SSD 108. It is to be noted that the definitions as described below are, that are based on design estimations, mere examples. In addition, the following described definitions are used to determine an optimum timing for warning a requirement for replacement of the SSD 108. Further, the definition of the data quantity to be written or the like in each of the partitions A to H of the SSD 108, is stored, for example, in the partition D that is provided for system data and is to be under a control of the system control part 122.

At first, FIG. 3A indicates definitions of write data size a, data write number of times b, and data write quantity c that are for each of the partitions A to H. Units of the data write number of times b and the data write quantity c are expressed in the unit of Mb (Megabit). In addition, the data write number of times b and the data write quantity c are daily basis values. Further, the data write quantity c is calculated by multiplying the write data size a with the data write number of times b. It is to be noted the data write number of times b and the data write quantity c may be expressed in terms of a specific duration other than a day.

FIG. 3A indicates that the write data size a of the partitions A and B is defined to be larger than the write data size a of the other partitions C to H. The reason is that, as described above, the partition A are provided for OS image and the partition B are provided for MFP controller control program, both the partition A and B are larger in to-be-installed program size than the other partitions C to H.

FIG. 3A indicates also that the data write number of times b of the partitions D and E is defined to be larger than the other partitions A to C and F to H. The reason is that, as previously described, the partition D are provided for system data and the partition E are provided for image handling, both the partition D and E require high frequency data write due to using each function of the MFP 100.

FIG. 3A indicates further that the partitions D and E are defined to be larger in data write quantity than the other partitions A to C and F to H. The reason is that, as described above, the partition D are provided for system data and the partition E are provided for image handling, both the partition D and E require high frequency data write due to using each function of the MFP 100, resulting in larger data write.

At this stage, a description is made as to a warning indication threshold value that determines an optimum timing for warning a requirement for replacement of the SSD 108 when the lifetime of the SSD 108 is close to end. It is to be noted that in the present exemplary embodiment the lifetime of the SSD 108 is defined such that the data write quantity of the SSD 108 sums up to a TBW (Tera Byte Written). In addition, the following warning indication threshold value is determined by a calculating operation of the system control part 122. More specifically, if the SSD 108 is the only storage device mounted on the MFP 100, all the partitions A to H that are used as illustrated in FIG. 3A. In this case, the sum of the data write quantities c, per day, of the Partitions A to H is about 17000 Mb. Increasing the sum of the data write quantities c will increase the number of cells in which data write occurs inside the SSD 108 and the number of the data write for the cells, that causes the SSD 108 to be closer to its lifetime.

In the present exemplary embodiment, as an optimum timing for warning a requirement for replacement of the SSD 108, a specific period of time, for example, 3 months, is described that is before the data write quantity reaches the Tera Byte Witten. The phrase “three months” means three months preceding reaching of the lifetime of the SSD 108. In addition, the lifetime of the SSD 108 means that the sum of the data write quantities c reaches the TBW with the result that the remaining available write capacity is 0. Further, the specified duration of “three months” as an optimum timing for warning a requirement for replacement of the SSD 108 may be set in advance or by operating the panel part 106.

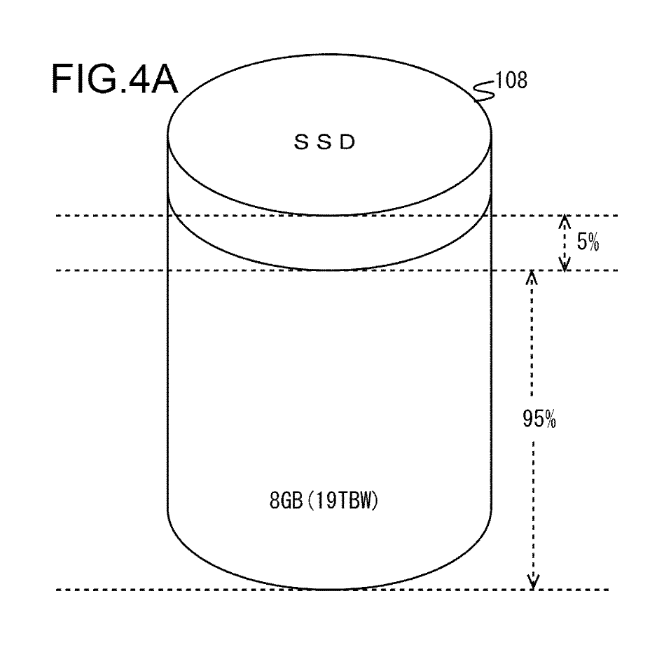

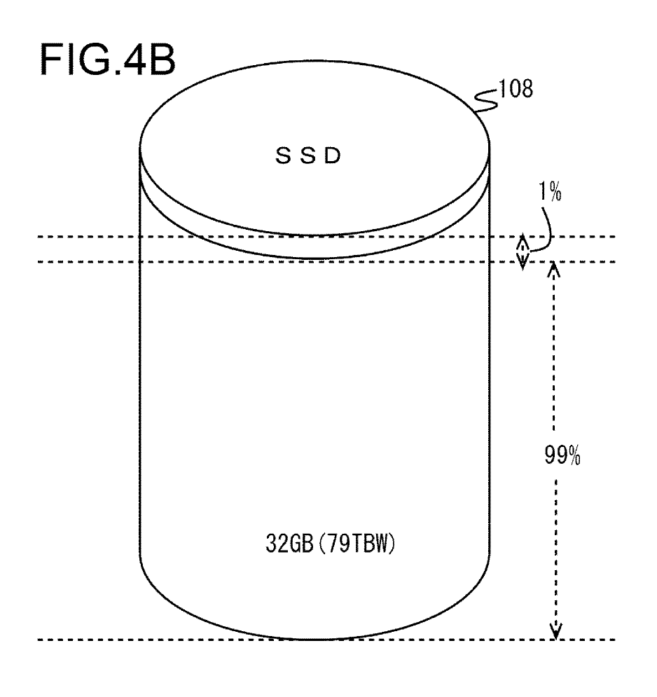

Here, as illustrated in FIG. 4A, the TBW when the SSD 108 of 8 GB is used is 19 TBW. As FIG. 4B also illustrates, the TBW when the SSD 108 of 32 GB is used is 79 TBW. The TBW, that is a design value of, for example, the SSD 108, will vary with the storage capacity, features, and performance of the SSD 108.

Then, for example, in a case where the SSD 108 of 8 GB is used, if a determination is made for warning a requirement for replacement of the SSD 108 three months before the lifetime of the SSD 108, the required is to sum up the data write quantities c during three months. In this case, given that the sum of the data write quantities c per day is about 17000 MB and the number of operation days of the MFP 100 is 20, the sum of the data write quantities c during three months is:

170000 (MB)×3 (months)×20 (Days: Operation days)=1020000 (MB)

More specifically, it is revealed that the time point at which the remaining data write capacity in the TBW (that is available data write capacity) comes to be 1020000 MB (about 1 TB) is the duration of three months before the lifetime of the SSD 108.

In view of the above, assuming that the sum of the data write quantities c for three months is A (TB) and a TBW as a guaranteed write capacity of the SSD 108 is B (TB), from the following formula

A (TB)÷B (TB) (Formula 1)

It is possible to calculate the warning indication threshold value.

Thus, using Formula (1) , if the sum of the data capacities c for three months is 1 (TB) and the TBW as the guaranteed write capacity is 19 (TB), the warning indication threshold value is:

1 (TB)÷B (TB)≈0.05

More specifically, as illustrated in FIG. 4A, when the possible data write quantity in the SSD 108 is 5% of the TBW, such a time point maybe used as an optimum timing of warning a requirement for replacement of the SSD 108.

It is to be noted that though the optimum timing is set here to be three months earlier than the lifetime of the SSD 108, the optimum timing may be allowed to be shorter or longer than three months. In this case, a setting is made for the changed optimum timing of warning a requirement for replacement of the SSD 108 by operating the panel part 106. Then, if the optimum timing is set to be two months, the system control part 122 determines a sum of data write quantities c during two months and substituting the resulting sum into formula (1) , (sum of data write quantities c during two months)÷19 (TB) , providing the warning indication threshold value.

In addition, in a case of an SSD 108 of 32 GB, the warning indication threshold value is, from formula (1),

1(TB)÷79 (TB)≈0.01

More specifically, as illustrated in FIG. 4B, when the possible data write quantity in the SSD 108 is 1% of the TBW, such a time point may be used as an optimum timing of warning a requirement for replacement of the SSD 108. In this case, similar to the above, the optimum timing may be allowed to be shorter or longer than three months.

It is to be noted that if the HDD 107 is optionally added, as illustrated in FIG. 3B, partitions E to H of the SSD 108 that are encircled by dotted lines are out of use. More specifically, as described above, the HDD 107 is larger than SSD 108 in storage capacity and therefore as shown in FIG. 2B, the partitions E′ to H′ of the HDD 107 are used instead of the partitions E to H.

In this case, a sum of the data write quantities c per day in the partitions A to D of the SSD 108 is about 5000 MB. In addition, on the assumption that the operating days of one month is 20 days, the sum of data write quantities for three months is:

5000 (MB)×3 (Months)×20 (days: operating days)=300000 (MB)

More specifically, when the remaining data write quantity of the TBW comes to be 300000 (about 0.3 TB) , such a time point is three months earlier that the lifetime of the SSD 108.

From the above, if the SSD 108 of 8 GB is used and the TBW is 19 TBW, the warning indication threshold value, formula (1) provides the warning indication threshold value as follows:

0.3 (TB)÷19 (TB)≈0.016

More specifically, if the HDD 107 is optionally added, when the possible data write quantity in the SSD 108 is 1.6% of the TBW, such a time point may be used as an optimum timing of warning a requirement for replacement of the SSD 108 of 8 GB.

In addition, similarly, in a case where the HDD 107 is optionally added, if the SSD 108 of 32 GB is used and the TBW is 79 TBW, formula (1) provides the warning indication threshold value as follows:

0.3 (TB)÷79 (TB)≈0.003

More specifically, if the HDD 107 is optionally added, when the possible data write quantity in the SSD 108 is 0.3% of the TBW, such a time point may be used as an optimum timing of warning a requirement for replacement of the SSD 108 of 32 GB.

In this, case, similar to the above, the optimum timing may be allowed to be shorter or longer than three months.

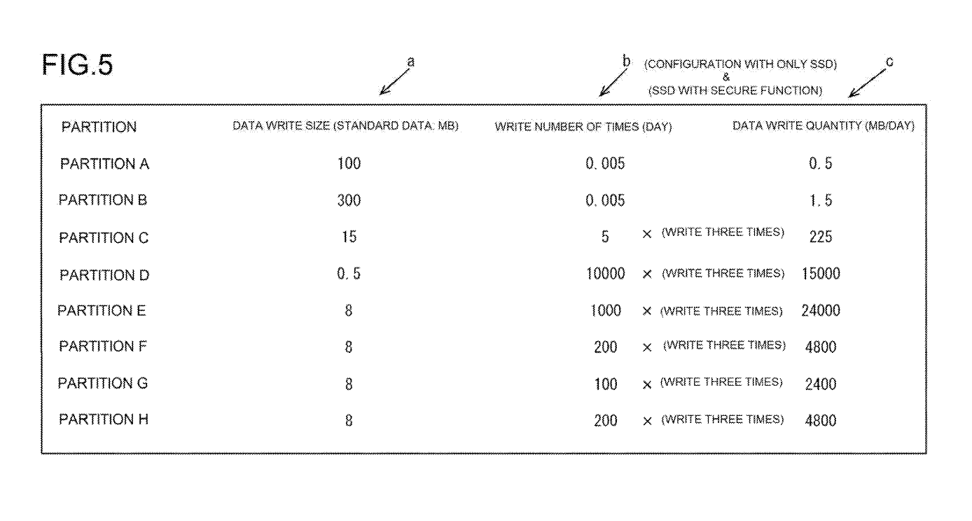

It is to be noted that if only the SSD 108 with a secure function is mounted on the MFP 100, as shown in FIG. 5, the data write number of times is tripled, as well known, in the partitions C to H that are related to user data.

In this case, a sum of the data write quantities c per day in the partitions A to D of the SSD 108 is about 51200 MB. In addition, on the assumption that the operating days of one month is 20 days, the sum of data write quantities for three months is:

51200 (MB)=3 (Months)=20 (days: operating days)=3072000 (MB)

More specifically, when the remaining data write quantity of the TBW comes to be 3072000 (about 3 TB) , such a time point is three months earlier that the lifetime of the SSD 108.

From the above, if the SSD 108 of 8 GB is used and the TBW is 19 TBW, the warning indication threshold value, formula (1) provides the warning indication threshold value as follows:

3 (TB)÷19 (TB)≈0.16

More specifically, when the possible data write quantity in the SSD 108 is 16% of the TBW, such a time point may be used as an optimum timing of warning a requirement for replacement of the SSD 108 of 8 GB with secure function.

In addition, similarly, if the SSD 108 of 32 GB with secure function is used and the TBW is 79 TBW, formula (1) provides the warning indication threshold value as follows:

3 (TB)÷79 (TB)≈0.04

More specifically, when the possible data write quantity in the SSD 108 is 4% of the TBW, such a time point may be used as an optimum timing of warning a requirement for replacement of the SSD 108 of 32 GB with secure function.

In this case, similar to the above, the optimum timing may be allowed to be shorter or longer than three months.

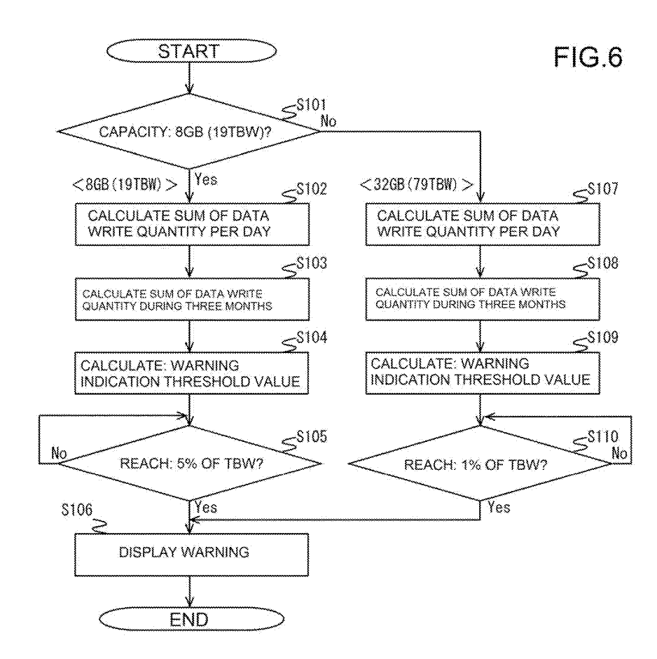

Next, with reference to FIG. 6, a description is made as to a method of warning a requirement for replacement of the SSD 108. It is to be noted that for purpose of explanation, the following description is made on the assumption that only the SSD 108, that is a nonvolatile memory, is mounted on the MFP 100. In addition, the SSD 108 has a storage capacitor of either 8 GB (19 TB) or 32 GB (79 TB). Further, the data write size a, the data write number of times b, and the data write quantity c of each of the Partitions A to H of the SSD 108 are predefined as shown in FIG. 3A. Moreover, the following explanation is made on the assumption that the warning indication threshold value is set to be 5% (three months) by the design estimation of the SSD 108.

(Step S101)

First of all, the system control part 122 confirms whether or not the SSD 108 has a storage capacity of 8 GB (19 TBW). If the system control part 122 determines that SSD 108 has a storage capacity of 8 GB (19 TBW) (STEP 101: Yes), the system control part 122 causes the procedure to go to STEP S102. On the contrary, if the system control part 122 does not determine that SSD 108 has a storage capacity of 8 GB (19 TBW) (STEP 101: No), the system control part 122 causes the procedure to go to STEP S107.

(Step S102)

The system control part 122 reads out the definition by the design estimation that is stored in, for example, the partition D in order to calculate the sum of the data write quantities c per day. In this case, as explained using FIG. 3A, the sum of the data write quantities c per day of the partitions A to H of the SSD 108 is about 17000 MB.

(Step S103)

The system control part 122 to calculate the sum of the data write quantities c for three months in order to determine the warning indication threshold value. In this case, the system control part 122, as described above, calculates the sum of the data write quantities c for three months on the assumption that the number of operation days of the MFP 100 is 20.

More specifically, the sum of the data write quantities c during three months is:

170000 (MB)×3(months)×20 (Days: Operation days)=1020000 (MB)

(Step S104)

The system control part 122 calculates the warning indication threshold value by the design estimation. In this case, based on the sum of the data write quantities c during three months, the system control part 122 determines that the time point at which the remaining data write capacity in the TBW (that is available data write capacity) of SSD108 comes to be 1020000 MB (about 1 TB) is the duration of three months before the lifetime of the SSD 108. Then, the system control part 122, using the aforementioned formula (1), calculates

1 (TB)÷B (TB)≈0.05

More specifically, the system control part 122 determines that 5% of the TBW is the warning indication threshold value.

(Step S105)

The system controller 122 determines whether or not the possible data write quantity in the SSD 108 reaches 5% of the TBW as the warning indication threshold value. If the system controller 122 determines that the possible data write quantity in the SSD 108 does not reach 5% of the TBW as the warning indication threshold value (STEP S105: No), the system control part 122 continues to determine whether the possible data write quantity in the SSD 108 reaches 5% of the TBW as the warning indication threshold value. On the other hand, the system controller 122 determines that the possible data write quantity in the SSD 108 reaches 5% of the TBW as the warning indication threshold value (STEP S105: Yes), the control part 122 causes the procedure to go to STEP S106.

(Step S106)

The system control part 122 causes the panel operation control part 119 to display warning a requirement for replacement of the SSD 108 on the panel part 106.

(Step S107)

Similar to STEP S102, the system control part 122 calculates the sum of the data write quantities c per day. In this case, similar to the above, the sum of the data write quantities c per day of the partitions A to H of the SSD 108 is about 17000 MB.

(Step S108)

The system control part 122 calculates, similar to STEP S103, the sum of the data write quantities c of the partitions A to H of the SSD 108 for three months. In this case, similar to the above, the system control part 122 calculates the sum of the data write quantities c for three months on the assumption that the number of operation days of the MFP 100 is 20.

More specifically, the sum of the data write quantities c during three months is:

170000 (MB)×3 (months)×20 (Days: Operation days)=1020000 (MB)

(Step S109)

The system control part 122 calculates, similar to STEP S104, the warning indication threshold value. In this case, based on the sum of the data write quantities c during three months, the system control part 122 determines that the time point at which the remaining data write capacity in the TBW (i.e. available data write capacity) comes to be 1020000 MB (about 1 TB) is the duration of three months before the lifetime of the SSD 108. Then, the system control part 122, using the aforementioned formula (1), calculates

1 (TB)÷79 (TB)≈0.01

More specifically, the system control part 122 determines that 1% of the TBW is the warning indication threshold value.

(Step S110)

The system controller 122 determines whether or not the possible data write quantity in the SSD 108 reaches 1% of the TBW as the warning indication threshold value. If the system controller 122 determines that the possible data write quantity in the SSD 108 does not reach 1% of the TBW as the warning indication threshold value (STEP S110: No), the system control part 122 continues to determine whether the possible data write quantity in the SSD 108 reaches 1% of the TBW as the warning indication threshold value. On the other hand, the system controller 122 determines that the possible data write quantity in the SSD 108 reaches 1% of the TBW as the warning indication threshold value (STEP S110: Yes), the control part 122 causes the procedure to go to the aforementioned STEP S106.

It is to be noted that the above description is made in a case where only the SSD 108, that is a nonvolatile memory, is mounted on the MFP 100. As described with reference to FIG. 3B, in a case where the HDD 107 is optionally added, similar to the above, it is possible to calculate the warning indication threshold value by calculating the data write quantities c for three months after calculating the data write quantities c per day of the Partitions A to D of the SSD 108.

In addition, as described with reference to FIG. 5, is a case where only the SSD 108, that is provided with a secure function, is mounted on the MFP 100, similar to the above, it is possible to calculate the warning indication threshold value by calculating the data write quantities c for three months after calculating the data write quantities c per day of the partitions A to D of the SSD 108.

In such a way, in the present exemplary embodiment, it is possible to calculate the warning indication threshold value by calculating the ratio of a multiplied value to the TBW (guaranteed write capacity), the multiplied value being a sum of the data write quantities per day that are defined for partitions (the for-system partition 108A of the SSD 108 (first memory) and the for-each-function partition 108B (first for-each-function partition)) and a specified duration (for example, three months) before the sum of the data write quantities c in the SSD 108 reaches the TBW (guaranteed write capacity). In addition the system control 122, that controls the data write in the for-system partition 108A and the for-each-function partition 108B (first for-each-function partition), is capable of causing the panel part 106 to display warning a requirement for replacement of the SSD 108 when the remaining data write quantity of the TBW (guaranteed write capacity) reaches the warning indication threshold value.

Thus, even if the data write quantities in the SSD 108 vary due to the system device configuration being in use and the function being in use, it is possible to cause the panel part 106 to display warning a requirement for replacement of the SSD 108 based on the warning indication threshold value provided by the design estimation, that makes it possible to provide an optimum indication timing for warning a requirement for replacement of the SSD 108.

In the aforementioned typical technique of the data storage control device, before reaching the guarantee rewrite number of times of the first nonvolatile memory, the data to be written in the first nonvolatile memory is stored in the second nonvolatile memory, that makes it possible to secure the data reliability.

Incidentally, in this data storage control device, the data write number of times in the partition of the first nonvolatile storage is in excess of a specified number of times, it is possible to think that of a display of warning indication of a requirement for replacement of the first nonvolatile memory. More specifically, it is believed that displaying the warning is possible before the first nonvolatile memory comes to its lifetime.

However, the display of warning a requirement for replacement of the first nonvolatile memory is made based on only the data write number of times in the partition of the first nonvolatile storage, that arises a problem in that the data write quantities in the first nonvolatile memory vary due to the system device configuration being in use and the function being in use, that fails provide an optimum indication timing for warning a requirement for replacement of the first nonvolatile memory.

In view of the aforementioned circumstances, the present disclosure is proposed whose object is to provide an electronic device and a method of warning a lifetime of memory both of which are capable of overcoming the aforementioned drawbacks.

Both the electronic device and the method of warning a lifetime of memory according to the present disclosure, even if the data write quantities in the first memory vary due to the system device configuration being in use and the function being in use, make it possible to cause the panel part to display warning a requirement for replacement of the first memory based on the warning indication threshold value, that enables a provision of an optimum indication timing for warning a requirement for replacement of the first memory.

While in the present exemplary embodiment the description is made in relation to the MFP 100 as the electronic device of the present disclosure, needless to say, the present disclosure may be applied to other electric devices including, for example, personal computers and mobile terminal devices that make use of the SSD 118 that is a nonvolatile memory.

What is claimed is:

1. An electronic device, comprising:
a panel part that displays information;
a first memory; and
a system control part that calculates a warning indication threshold value, based on a data write quantity written in a first memory, in a first time duration before the data write quantity to the first memory reaches a guaranteed write capacity,
the system control part controlling a data write to the first memory and causing the panel part to display warning a requirement for replacement of the first memory when a remaining write capacity of the guaranteed write capacity reaches the warning indication threshold value.

2. The electronic device according to claim 1,
wherein the first memory has a partition, and
wherein the system control part controls the data write to the partition by calculating the alarm indication threshold value based on the data write quantity written in the first memory in the first time duration being obtained by a multiplication of a sum of the data write quantity per a second time duration defined for the partition and the first time duration.

3. The electronic device according to claim 1 further comprising a second memory, wherein,
the first memory includes a for-system partition and a first for-each-function partition,
the second memory is larger than the first memory in storage capacity and includes a second for-each-function partition in which data is written that is to be written in the first for-each-function partition, and
the system control part controls the data write to the for-system partition and the second for-each-function partition by calculating the warning indication threshold value based on the data write quantity written in the first memory in the first time duration being obtained by a multiplication of a sum of the data write quantity per a second time duration defined for the for-system partition and the first time duration.

4. The electronic device according to claim 3,
wherein the second memory is optionally provided,
wherein when the second memory is not mounted to the electronic device, the system control part controls the data write to the for-system partition and the first for-each-function partition by calculating the warning indication threshold value based on the data write quantity written in the first memory in the first time duration being obtained by a multiplication of a sum of the data write quantity per a second time duration defined for the for-system the partition and the first for-each function partition, and the first time duration, and
wherein if the second memory is mounted to the electronic device, the system control part controls the data write to the for-system partition and the second for-each-function partition by calculating the warning indication threshold value based on the data write quantity written in the first memory in the first time duration being obtained by a multiplication of a sum of the data write quantity per a second time duration defined for the for-system partition, and the first time duration.

5. The electronic device according to claim 1, wherein the system control part calculates the warning indication threshold value based on a ratio of the data write quantity written in the first memory for the first duration to the guaranteed write capacity.

6. The electronic device according to claim 1, wherein the first duration is capable of being set by manipulating the panel control part.

7. A non-transitory computer-readable storage medium in which is stored a memory lifetime warning program that is executable by a computer of an electronic device, the memory lifetime warning program when being executed by the computer, causes the computer
to calculate a warning indication threshold value based on a data write quantity written in a first memory for a first duration before the data quantity written in the first memory reaches a guaranteed write capacity of the first memory,
to control a data write in the first memory, and
to cause the panel part to display warning a requirement for replacement of the first memory when a remaining write capacity of the guaranteed write capacity reaches the warning indication threshold value.
